(19) United States
(12) Patent Application Publication
(10) Pub. No.: US 2020/0182083 A1
(43) Pub. Date: Jun. 11, 2020

(54) VISUAL DETECTION OF FAN CASE LINER DAMAGE FOR TURBINE ENGINE

(71) Applicant: Gulfstream Aerospace Corporation, Savannah, GA (US)

(72) Inventors: Scott Martin, Savannah, GA (US); Mike Lucas, Savannah, GA (US); Andy Slater, Savannah, GA (US); Paul Woodcock, Winston-Salem, NC (US)

(73) Assignee: Gulfstream Aerospace Corporation, Savannah, GA (US)

(21) Appl. No.: 16/702,714

(22) Filed: Dec. 4, 2019

Related U.S. Application Data
(60) Provisional application No. 62/776,263, filed on Dec. 6, 2018.

(51) Int. Cl. F01D 21/04; F01D 25/24

(52) U.S. Cl. CPC F01D 21/045; F02K 3/06; F01D 25/24

(57) ABSTRACT

A turbofan engine assembly includes a fan, a fan case, and a fan case liner. A fan blade has a fan blade tip at the distal end of the fan blade. The fan case liner is spaced apart from the fan blade tip by a clearance distance, is disposed between the fan case and the fan blade tip, and includes an abradable base layer and an abradable indicator layer. The abradable base layer is in closest proximity to the fan and has a first visual characteristic and a depth matching a clearance threshold allowable value. The abradable indicator layer is disposed between the abradable base layer and the fan case. The abradable indicator layer has a second visual characteristic that is visually distinguishable from the first visual characteristic to indicate when the abradable base layer has worn away such that the clearance distance has exceeded the clearance threshold allowable value.

### CROSS-REFERENCE TO RELATED APPLICATION

This application claims the benefit of U.S. Provisional Application No. 62/776,263, filed Dec. 6, 2018, which is incorporated herein by reference in its entirety.

### TECHNICAL FIELD

The present disclosure generally relates to systems, turbofan engine assemblies, and fan case liners for detecting damage to turbofan engine assemblies, and more particularly relates to systems, turbofan engine assemblies, and fan case liners with different colored abradable materials that may be visually inspected to detect damage to a fan case liner.

### BACKGROUND

Fans in a turbofan engine rotate within a cylindrical fan case liner. A clearance between the fan case liner and the tips of the fan blades is essential during normal operation, but heavy rubs of the tips of the blades on the fan case liner abradable during abnormal events can impact the safe operation and performance of the engine.

Several conditions may cause the fan blade tips to contact the fan case liner. For example, the blade tips may contact the fan case liner due to severe aircraft maneuvers, atmospheric turbulence, engine vibrations, or when the engine ingests hard or soft foreign material. When the blades contact the fan case liner, the fan blades may rub out the sacrificial fan case abradable of the fan case liner. The abradable layer of the liner protects the blades from tip damage as the blades deflect into the fan case.

The fan case liner may be damaged when ice accumulated on the fan blades sheds and flings outward to impact the fan case liner. These ice impact events often result in pitting or cratering of the fan case liner abradable and can lead to performance loss and operability margin reduction if not repaired between major events.

The clearances between fan blade tips and fan case liner are typically measured with feeler gauges to determine whether the fan tip clearance is beyond a predetermined safety or performance limit. Inspection of the fan case liner is required to ascertain the degree of impact damage from an ice impact event.

### SUMMARY

In a first non-limiting embodiment, A turbofan engine assembly includes a fan, a fan case, and integral fan case liner. The fan has a fan blade with a fan blade tip at the distal end of the fan blade. The fan case circumscribes the fan. The fan case liner is spaced apart from the fan blade tip by a clearance distance. The fan case liner is located between the fan case and the fan blade tip. The fan case liner could include an abradable base layer and an abradable indicator layer. The abradable base layer is in closest proximity to the fan tips, and a depth matching a clearance threshold value that is based on a maximum allowable clearance between the fan case liner and the fan blade tip. The abradable indicator layer is disposed between the abradable base layer and the fan case. The abradable indicator layer has a second visual characteristic that is visually distinguishable from the first visual characteristic to indicate when the abradable base layer has worn away such that the clearance distance has exceeded the clearance allowable value. The base and indicator layers may be of different material composition, or simply distinguishable by a color dye.

In a second non-limiting embodiment, a fan case liner for a turbofan engine assembly has a fan and a fan case. The fan has a fan blade with a fan blade tip at the distal end of the fan blade and the fan case circumscribes the fan. The fan case liner could include an abradable base layer and an abradable indicator layer. The abradable base layer is in closest proximity to the fan blade tips. The abradable base layer has first visual characteristic and a depth matching an allowable clearance threshold value that is based on a maximum clearance between the fan case liner and the fan blade tip. The abradable indicator layer is located between the abradable base layer and the fan case. The abradable indicator layer has a second visual characteristic that is visually distinguishable from the first visual characteristic to indicate when the abradable base layer has worn away such that the clearance distance has exceeded the allowable clearance threshold value. The fan case liner is configured to be spaced apart from the fan blade tip by a clearance distance and to be located between the fan case and the fan blade tip.

### BRIEF DESCRIPTION OF THE DRAWINGS

Advantages of the system and method described herein will be readily appreciated, as the same becomes better understood by reference to the following detailed description when considered in connection with the accompanying drawings wherein:

FIG. 1 illustrates a turbofan engine assembly in accordance with the teachings of the present disclosure; and

FIGS. 2-3 illustrate cross sections of an abradable fan case liner of the turbofan engine assembly of FIG. 1 in accordance with the teachings of the present disclosure.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

Various embodiments disclosed herein describe systems that give a quick visual indication of the amount of damage incurred in the fan case liner due to rub-out by the fan blades or impact damage from ice or other foreign objects hitting the fan case liner.

Various embodiments use different colors of abradable fan case liner material to ascertain the amount of fan blade rub-out wear or impact damage to the fan case liner. The fan case liner may be made of an abradable material with different discrete colors at different depths into the liner. Thus, different colors become visible as the rub-out or impact pitting/cratering removes material deeper into the liner. This allows for the pilot or maintenance crew to look into the engine inlet and make a quick visual inspection of the fan case liner damage between flights.

The colored layers of abradable liner may be continuous around the circumference of the fan case liner or may be discrete abradable plugs embedded at key locations around the circumference of the baseline abradable liner. This simple color-coded visual method of inspection may reduce the frequency of more detailed and time consuming blade tip clearance measurements and works to help enhance aircraft safety and engine performance. The embodiment of discreet abradable plugs, introduces the potential to rework existing fan case assemblies to provide aforementioned wear indication.

In one embodiment, the abradable layer closest to the engine centerline is the baseline abradable color. The next color layer would begin at a liner depth level that corresponds to a damage caution warning that may necessitate more detailed fan tip clearance or pit size measurements. A third color layer would begin at a liner depth level that invokes liner repair or replacement.

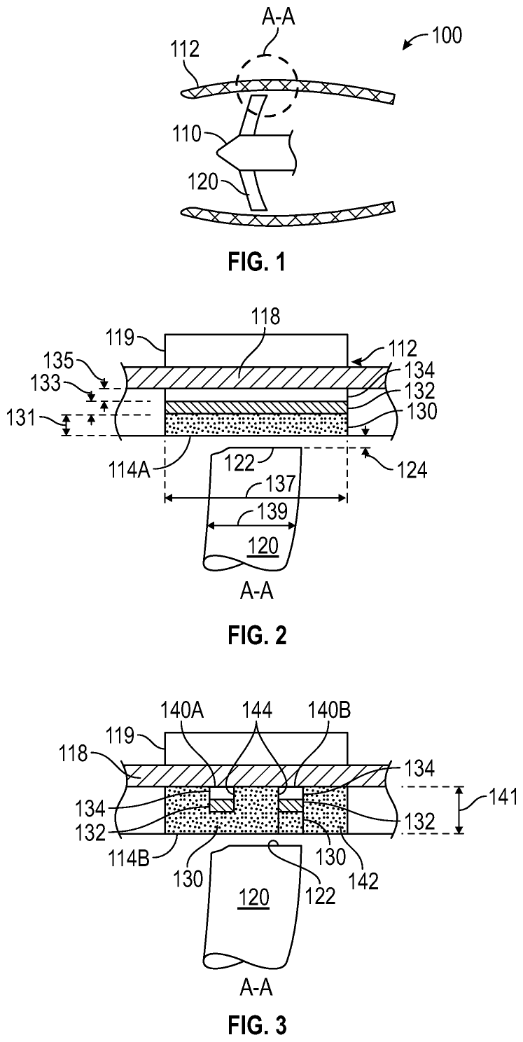

Referring now to FIGS. 1-3, a turbine engine assembly 100 is illustrated in accordance with some embodiments. Turbine engine assembly 100 includes a fan 110, a fan case 112, and a fan case liner 114A or 114B. Fan case 112 circumscribes fan 110 and includes a main portion 118 and a fan blade containment ring 119.

Fan 110 rotates within fan case 112 and includes fan blades 120 that extend from a base of fan 110. It should be appreciated that principles of the present disclosure apply to other rotatable components that may damage a casing of a different type of assembly without departing from the scope of the present disclosure. Fan blades 120 each have a fan blade tip 122 at a distal end of the respective fan blade 120. Fan blade tip 122 is spaced apart from fan case liner 114A or 114B by a clearance distance 124. Clearance distance 124 may increase over time due to rub-out events in which fan blade tips 122 or ice from fan blades 120 contact fan case liner 114A or 114B and wear away fan case liner 114A or 114B. A maximum clearance between fan blade tip 122 and fan case liner 114A or 114B indicates the maximum distance before damage to turbofan engine assembly 100 may occur. For example, the maximum clearance may be a distance between fan blade tip 122 and fan case 112.

Fan case liner 114A (illustrated in FIG. 2) is disposed between fan case 112 and fan blade tip 122. Fan case liner 114A includes an abradable base layer 130, an abradable indicator layer 132, and an abradable warning layer 134. Layers 130, 132, and 134 have similar physical properties for abrading when contacted by fan blade tip 122 and/or ice shed from fan blades 120. Each of layers 130, 132, and 134, however, has a different visual characteristic by which a human eye can visually distinguish between the layers. In the example provided, the visual characteristic is a color dye. In some embodiments, other visual characteristics are used. For example, reflective materials may be embedded in some layers to indicate which layer is exposed.

Abradable base layer 130 is disposed proximate the fan and is exposed directly to fan blade tip 122 in the initial installation condition in which no wearing of fan case liner 114A has yet occurred. Abradable base layer 130 has a first visual characteristic and a depth 131 matching a clearance threshold value that is based on a maximum clearance between the fan case liner and the fan blade tip. In the example provided, the first visual characteristic is a black or blue color much like the color of a conventional fan case liner so that the fan case liner looks substantially the same as a conventional fan case liner in the absence of wear. The normal operating clearance threshold value is the amount of wear permitted before abradable indicator layer 132 is visible to indicate that wear has occurred and should be monitored and/or inspected. The value of the normal operating clearance threshold value will vary by implementation.

Abradable indicator layer 132 is disposed between abradable base layer 130 and fan case 112. In the example provided, abradable warning layer is additionally disposed between abradable indicator layer 132 and fan case 112. Abradable indicator layer has a second visual characteristic that is visually distinguishable from the first visual characteristic to indicate when the abradable base layer has worn away such that the clearance distance has exceeded the normal operating clearance threshold value. In the example provided, the second visual characteristic is a second color, such as amber/yellow. A depth 133 of abradable indicator layer 132 matches a clearance warning value that is based on the maximum clearance between the fan case liner and the fan blade tip to indicate that the fan case liner has abraded more than the allowable clearance limit value and should be inspected. For example, clearance warning limit value may be a predefined percent of the maximum clearance at which fan case liner 114A should be repaired or replaced after consideration of depth 131 that has already worn away. In all cases the Aircraft Maintenance Manual (AMM) criteria takes precedence.

Abradable warning layer 134 is disposed between abradable indicator layer 132 and fan case 112 and has a third visual characteristic that is different from the first visual characteristic and the second visual characteristic. In the example provided, the third visual characteristic is selected to convey that the fan case liner should be repaired or replaced. For example, the third visual characteristic may be the color red that is typically associated with warnings on aircraft.

Referring now to FIG. 2, and with continued reference to FIG. 1, a first configuration of a fan case liner is illustrated in accordance with some embodiments. Abradable base layer 130, abradable indicator layer 132, and abradable warning layer 134 each extend substantially continuously around an entire circumference of fan case 112. In other words, abradable base layer 130, abradable indicator layer 132, and abradable warning layer 134 are shaped substantially as cylindrical shells that surround fan 110 and fan blades 120. Accordingly, wear at any point around fan case liner 114A will be detectable on visible inspection when abradable indicator layer 132 and/or abradable warning layer 134 are exposed.

In the example provided, abradable base layer 130 of fan case liner 114A has a first width 137 and the abradable indicator layer 132 has a second width. The first width and the second width are the same and are greater than a depth 139 of fan blade tip 122. In other words, fan blade tip 122 will expose abradable indicator layer 132 when wearing away abradable base layer 130 anywhere in the rotation plane of fan 110.

Referring now to FIG. 3, and with continued reference to FIGS. 1-2, a second configuration of a fan case liner is illustrated in accordance with some embodiments. Fan case liner 114B is similar to fan case liner 114A, where like numbers refer to like components. Fan case liner 114B, however, includes at least the abradable indicator layer 132—and in some embodiments the abradable warning layer 134—as plugs 140A or 140B.

Fan case liner 114B is a full depth 141 liner with an abradable main portion 142 that defines at least one cavity 144. Main portion 142 is the same material with the same first visual characteristic as of abradable base layer 130. Abradable base layer 130, abradable indicator layer 132, and abradable warning layer 134 form plug 140B disposed in cavity 144. Cavity 144 for plug 140B is an aperture extending an entire depth 141 of fan case liner 114B. Plug 140B is disposed in the cavity and has a depth that is the same as the entire depth.

Plug 140A is formed from abradable indicator layer 132 and abradable warning layer 134. Cavity 144 for plug 140A extends from fan case liner 118 to a portion of main portion 142 that defines abradable base layer 130. Accordingly, plug 140A abuts fan case 112.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those of ordinary skill in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A turbofan engine assembly, comprising:
a fan having a fan blade with a fan blade tip at a distal end of the fan blade;
a fan case circumscribing the fan; and
a fan case liner spaced apart from the fan blade tip by a clearance distance, the fan case liner disposed between the fan case and the fan blade tip, the fan case liner comprising:
an abradable base layer proximate the fan, the abradable base layer having first visual characteristic and a depth matching a clearance threshold value that is based on a normal operating clearance between the fan case liner and the fan blade tip; and
an abradable indicator layer disposed between the abradable base layer and the fan case, the abradable indicator layer having a second visual characteristic that is visually distinguishable from the first visual characteristic to indicate when the abradable base layer has worn away such that the clearance distance has exceeded the clearance threshold value and should be inspected.

2. The turbofan engine assembly of claim 1, wherein the first visual characteristic is a first color and the second visual characteristic is a second color.

3. The turbofan engine assembly of claim 1, wherein the fan caser liner circumscribes the fan.

4. The turbofan engine assembly of claim 1, wherein the abradable base layer and the abradable indicator layer each extend substantially continuously around an entire circumference of the fan case.

5. The turbofan engine assembly of claim 1, wherein the abradable base layer has a first width and the abradable indicator layer has a second width, and wherein the first width and the second width are the same.

6. The turbofan engine assembly of claim 5, wherein the first width is greater than a depth of the fan blade tip.

7. The turbofan engine assembly of claim 1, wherein the fan case liner further includes a full depth liner defining a cavity, wherein the abradable base layer and the abradable indicator layer form a plug disposed in the cavity.

8. The turbofan engine assembly of claim 7, wherein a portion of the cavity forms the abradable base layer and the plug abuts the fan case.

9. The turbofan engine assembly of claim 7, wherein the cavity is an aperture extending an entire depth of the fan case liner, and wherein the plug is disposed in the cavity and has a depth that is the same as the entire depth.

10. The turbofan engine assembly of claim 1, wherein the fan case liner further includes an abradable warning layer disposed between the abradable indicator layer and the fan case and having a third visual characteristic that is different from the first visual characteristic and the second visual characteristic, wherein the depth of the abradable indicator layer matches a clearance warning value that is based on the normal operating clearance between the fan case liner and the fan blade tip to indicate that the fan case liner has abraded more than the clearance threshold value and should be inspected.

11. The turbofan engine assembly of claim 10, wherein the third visual characteristic is selected to convey that the fan case liner should be repaired or replaced.

12. A fan case liner for a turbofan engine assembly having a fan and a fan case, the fan having a fan blade with a fan blade tip at a distal end of the fan blade and the fan case circumscribing the fan, the fan case liner comprising:
an abradable base layer proximate to the fan, the abradable base layer having first visual characteristic and a depth matching a clearance threshold value that is based on a normal operating clearance between the fan case liner and the fan blade tip; and
an abradable indicator layer disposed between the abradable base layer and the fan case, the abradable indicator layer having a second visual characteristic that is visually distinguishable from the first visual characteristic to indicate when the abradable base layer has worn away such that the clearance distance has exceeded the clearance threshold value,
wherein the fan case liner is configured to be spaced apart from the fan blade tip by a clearance distance and to be disposed between the fan case and the fan blade tip.

13. The fan case liner of claim 12, wherein the first visual characteristic is a first color and the second visual characteristic is a second color.

14. The fan case liner of claim 12, wherein the fan caser liner is configured to circumscribe the fan.

15. The fan case liner of claim 12, wherein the abradable base layer has a first width and the abradable indicator layer has a second width, and wherein the first width and the second width are the same.

16. The fan case liner of claim 15, wherein the first width is greater than a depth of the fan blade tip.

17. The fan case liner of claim 12, wherein the fan case liner further includes a full depth liner defining a cavity, wherein the abradable base layer and the abradable indicator layer form a plug disposed in the cavity.

18. The fan case liner of claim 17, wherein a portion of the cavity forms the abradable base layer and the plug is configured to abut the fan case.

19. The fan case liner of claim 17, wherein the cavity is an aperture extending an entire depth of the fan case liner, and wherein the plug is disposed in the cavity and has a depth that is the same as the entire depth.

20. The fan case liner of claim 12, wherein the fan case liner further includes an abradable warning layer configured to be disposed between the abradable indicator layer and the fan case and having a third visual characteristic that is different from the first visual characteristic and the second visual characteristic, wherein the depth of the abradable indicator layer matches a clearance warning value that is based on the normal operating clearance between the fan case liner and the fan blade tip to indicate that the fan case liner has abraded more than the clearance threshold value and should be inspected.
